(19) United States
(12) Patent Application Publication
(10) Pub. No.: US 2020/0101631 A1
(43) Pub. Date: Apr. 2, 2020

(54) METHOD AND APPARATUS OF A KNIFE WITH A CUSTOMIZABLE RELEASE STIFFNESS, SELF-CLEANING WITH A WIPER AND CONTROLLED ROTATION BETWEEN TWO END-POINTS

(71) Applicant: Will Moon Custom Knives LLC, Apex, NC (US)

(72) Inventors: William Victor Moon, Apex, NC (US); Billy Gayle Moon, Apex, NC (US)

(73) Assignee: Will Moon Custom Knives LLC, Apex, NC (US)

(21) Appl. No.: 16/148,082

(22) Filed: Oct. 1, 2018

(51) Int. Cl. B26B 1/04; B25F 1/04; B08B 1/00

(52) U.S. Cl. CPC B26B 1/04; F41B 13/08; B08B 1/006; B25F 1/04

(57) ABSTRACT

An apparatus and method to a folding and a partially rotational device, comprising: stabilizing the frame holder of the device for the axis on which a partially rotational part rotates; spindle locking the partial rotation at two-ends using a spindle with screws at each-end of the spindle; defining the two-ends for the rotation with two or more stop pins; allowing the rotation with two or more compression springs; installing and cleaning the compression springs using a wiper; wherein tension of the rotation is adjusted by placement of one or more of the wiper or compression spring length.

### FIELD OF THE TECHNOLOGY

The present disclosure relates to method and apparatus for a device with a folding and partially rotational part, for example, a knife, with a customizable release stiffness, self-cleaning wiper and controlled rotation between two-end points. In particular, knife designs with varying knife blades and holding frames can be adjusted for rotational tension and have a longer life with durable components that are self-maintaining.

### BACKGROUND

There are different foldable pocket-knives available in the market that use standard opening and closing locking mechanisms. For example, lockback, liner lock, frame lock, axis lock, slip joint and friction folder are some of the common types of locks used with foldable pocket knives. Portability is one of the key features of foldable pocket-knives. When opened, the knives have to give you balance, ergonomics, and a stable blade that can be utilized. When closed, the user wants to be free of worry to be hurt by any sharp edges. Foldable features come at the cost of rigid, repeated hard use.

In particular, for example, the axis lock uses a solid locking bar that is threaded on one side with a male thread with a customized tool that goes to make the thread. A single coil spring is attached to inside of a solid guide rod. A carrier that slides onto the guide rode through a bored hold is used to pushforward on the locking bar making the lock tension non-adjustable. The axis lock is a single material and cannot be color matched to other screws in the knife if they are made of a different material. The axis lock also uses single components that can be replaced only when the knife is fully disassembled.

In the prior art, many designs include a single stop pin that is used to define the opening point in the rotation and does not include a stop pin for closing movement of the knife. Such designs have a limited number of blade shapes that the frame can accommodate, and the bottom of the prior art frames have to be open to accommodate over travel during closure.

The knife designs in the market today have the take it or leave it in terms of locking opening and closing mechanisms. For example, a young adult may be agile and want more tension versus use by a senior citizen might require a more relaxed tension. The very use of the device requires that frequent use will accumulate dust and debris in different parts of the device. Collection of the dust and debris makes the knife further difficult to use and operate as days go by and the newness of the device is lost. Servicing a knife by fully disassembling it might void its warranty from the manufacturer.

While there are different knife designs available currently in the industry, the current knife designs last only for a year or two before breaking. The parts used are not robust and the mechanical designs are not meant to last long. None of them allow customization of the rotation tension per user taste. There is no easy way of cleaning these knives without disassembling the entire knife.

### SUMMARY

One aspect of the present disclosure relates to an apparatus and method to a folding and a partially rotational device, comprising: stabilizing the frame holder of the device for the axis on which a partially rotational part rotates; spindle locking the partial rotation at two-ends using a spindle with screws at each-end of the spindle; defining the two-ends for the rotation with two or more stop pins; allowing the rotation with two or more compression springs; installing and cleaning the compression springs using a wiper; wherein tension of the rotation is adjusted by placement of one or more of the wiper or compression spring length.

The apparatus and method to a folding and a partially rotational device, wherein the spindle can be replaced without disassembling all the parts of the device.

The apparatus and method to a folding and a partially rotational device, wherein the wiper removes debris collected during the rotation of the device.

The apparatus and method to a folding and a partially rotational device, wherein one of the two-ends is the stop point when the device is closed that prevents excessive rotation on closing and protects the holder.

The apparatus and method to a folding and a partially rotational device, wherein one of the two-ends is the stop point that allows the device to be used as a rigid knife when opened.

The apparatus and method to a folding and a partially rotational device, wherein the spindle acts as a tensioned stop point that prevents the device from accidently being closed.

The apparatus and method to a folding and a partially rotational device, wherein the partially rotational part is a knife blade and the knife blade is one or more of the following: clip point, drop point, tanto, sheepsfoot, dagger or needle point, spear point, trailing point, gut hook, bowie shape, hawkbill pruner, or wharncliffe shape.

The apparatus and method to a folding and a partially rotational device, wherein the partially rotational part is one or more of the following handle tools: comb, screwdriver, wrench, pick, plyers or flashlight.

The apparatus and method to a folding and a partially rotational device, wherein the wiper further comprising of two parts that are a female threaded part and a male threaded part installed into the female threaded part.

The apparatus and method to a folding and a partially rotational device, further comprising one of the following: increasing the length of the wiper or the compression spring to increase the rotation tension of the device; or decreasing the length of the wiper or the compression spring to decrease the rotation tension of the device.

In various embodiments, the system and method of folding, locking, opening and dosing, adjusting rotational tension and self-cleaning mechanisms compatibility features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

Different embodiments described herein include components or structures to perform the described functionality. A component as used in here refers to a software or hardware component that may include a dedicated or shared processor and, typically, firmware or software modules executed by the processor. Depending upon implementation-specific or other considerations, a component can be centralized or its functionality distributed. A component may include special purpose hardware, firmware, or software embodied in a computer-readable medium for execution by the processor.

### BRIEF DESCRIPTION OF THE DRAWINGS

The embodiments of this invention are illustrated by way of example and not limitation in the figures of the accompanying drawings, in which like references indicate similar elements and in which:

FIG. 1 depicts a diagram illustrating an example of a foldable pocket knife that has customizable release tension, self-cleaning with wiper and controlled rotation between two end-points.

FIG. 2 depicts a diagram illustrating an example of a foldable pocket knife that has customizable release tension, self-cleaning with wiper and controlled rotation between two end-points with a transparent spring hook body to show the mechanical design from another perspective.

FIG. 3 a diagram illustrating an example of a foldable pocket knife that has customizable release tension, self-cleaning with wiper and controlled rotation between two end-points in open position.

FIG. 4 a diagram illustrating an example of the rotational part of a foldable pocket knife that has customizable release tension, self-cleaning with wiper and controlled rotation between two end-points.

FIG. 5 a diagram illustrating an example of a foldable pocket knife that has customizable release tension, self-cleaning with wiper and controlled rotation between two end-points highlighting the assembling and repair.

FIG. 6 is a diagram illustrating the wiper mechanism that is used for self-cleaning and customizing the rotational tension in one embodiment.

FIG. 7 is a diagram illustrating the spindle-lock component used in one embodiment.

FIG. 8 is a photograph with some disassembled parts of a device according to one embodiment.

FIG. 9 is a photograph with some disassembled parts of a device according to one embodiment.

FIG. 10 is a diagram illustrating an example of a spindle lock components according to one embodiment.

FIG. 11 is a flow diagram illustrating an example of steps of method in an apparatus and method of a knife with a customizable release stiffness, self-cleaning with a wiper and controlled rotation between two end-points.

FIG. 12 is a schematic diagram of exemplary wiper component with varying lengths, according to one embodiment.

FIG. 13 is a schematic diagram of exemplary compression spring component with varying lengths, according to one embodiment.

Other components of the present embodiments will be apparent from the accompanying drawings and from the detailed description that follows.

### DETAILED DESCRIPTION OF THE DRAWINGS

The apparatus and method of a knife with a customizable release stiffness, self-cleaning with a wiper and a controlled rotation between two end-points allows flexible design configurations that last long and are stable. A combination of a spindle, two stop pins and two or more compression springs form an apparatus that on one hand can prevent a knife blade from being closed so far into the handle of a foldable knife that the sharp edge of the blade contacts the handle material causing damage and on the other hand, when the blade is opened, it prevents the blade from being opened to far that it can't be used as a rigid knife when cutting while at the same time, it prevents the knife from accidentally closing and potentially causing physical harm to the knife user.

By using “compression springs” over other types of springs used in prior art, including the omega spring, the spring life is greatly extended. It is known in the art that compression springs have an effective life of greater than 1000× longer than a simple loop spring like the omega spring.

By using a spindle that can be inserted and removed from the outside of the knife, the device is easier to work on. The spindle design is robust and has two-sides, allowing a partial opening and cleaning of one side of the device.

The use of the wiper, both keeps debris out of the mechanism and allows the spring tension to be adjusted to taste. The tail of the wiper makes it easier to work on the spring mechanism.

Different embodiments described herein include components or structures to perform the described functionality. A “component,” as used in this paper, includes a dedicated or shared processor and, typically, firmware or software modules executed by the processor. Depending upon implementation-specific or other considerations, an engine can be centralized or its functionality distributed. A component can include special purpose hardware, firmware, or software embodied in a computer-readable medium for execution by the processor.

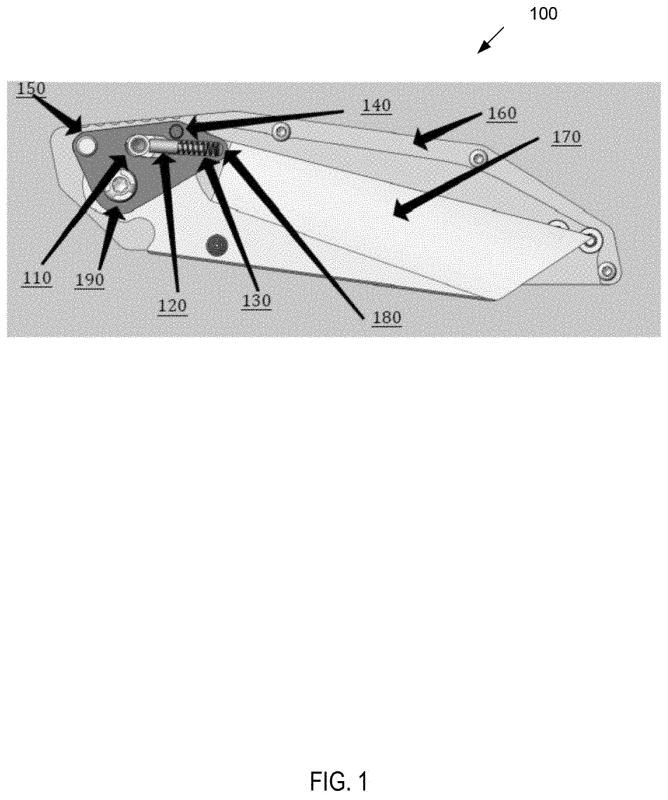

In one embodiment, FIG. 1 shows a typical knife 100 according to one embodiment, with several parts removed for clarity. Part 110 is the “spindle” which is shown without a cover screw for clarity. Part 120 is the wiper that interfaces between the spindle 110 and the compression spring 130. Part 130 is a compression spring. Two or more compression springs 130 are used in each knife. Part 140 is a stop pin used to assure closure. Part 150 is a stop pin used to assure that the blade can't open beyond a designed point. Part 160 is the back half of the knife frame. Part 170 is a typical knife blade. In other embodiments, any number of different blade shapes can be used in the same design by adjusting the position of Part 140 to map to movement based on the shape of the blade. Part 180 is a spring cover used for the purpose of retaining the mechanism. Part 190 is the pivot about which the knife blade can rotate.

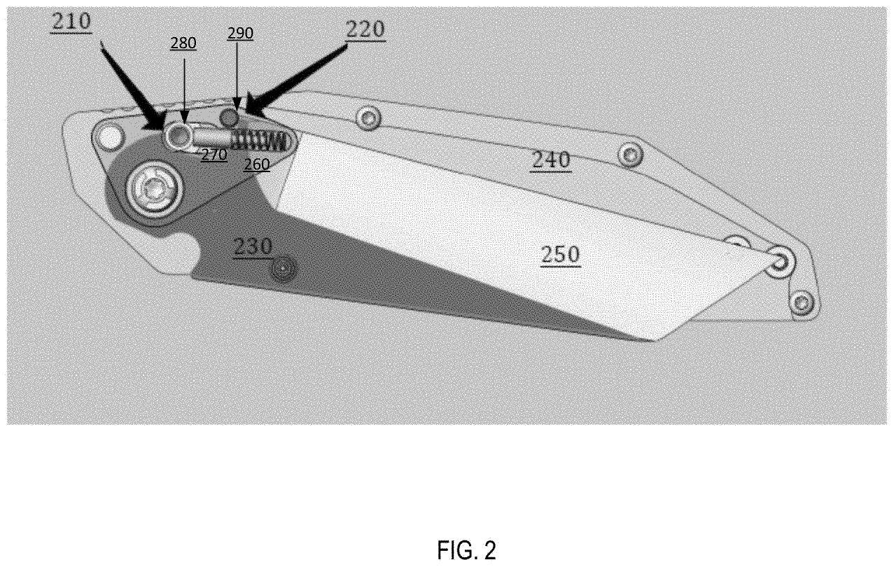

In one embodiment, FIG. 2 shows the spring cover 230 from FIG. 1 in transparent form. Part 210 shows how the shape of the blade contains a “hook” which engages the spindle in the closed position. The pressure of the compression spring 260 against wiper 270 causes the spindle 280 to engage hook 210 to keep the knife blade from “falling out” of the knife frame while closed. Additionally, stop pin 290 is shown engaged against a second face of the blade at 220. This prevents the knife blade 250 from being pushed down into the frame to the point that the sharp edge of the blade would impact frame 240.

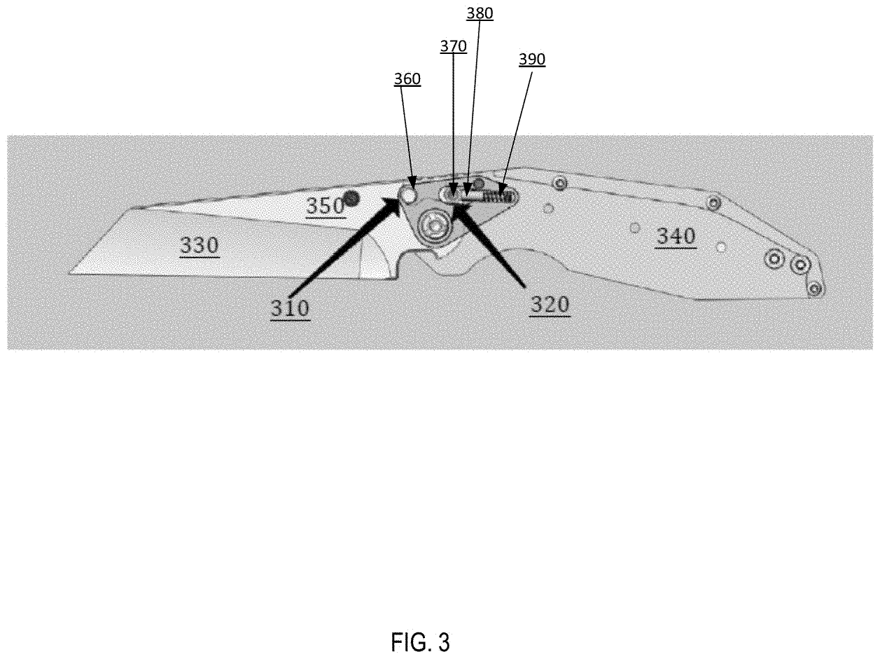

FIG. 3 shows the mechanism with the knife blade open. Here we see that a second spot on the blade, 310 rests against stop pin 360 preventing the blade from rotating any further open. Additionally, spindle 370 is pressed forward by wiper 380 and compression spring 390 until the spindle 70 interfaces a ramp on the back of the blade. When in this position, spindle 370 prevents the knife blade from accidently closing. To dose the knife, the spindle 370 must be pulled back to the right as shown in the diagram, compressing 380 and 390 until it clears the back of the knife blade allowing the knife to be closed. Part 320 shows the point of contact between the spindle 370 and the wiper 380 and compression spring 390 parts. Part 330 is the knife blade with a particular shape known as the Wharncliffee shape attached to the knife cover 350 with hooks for its motion at both ends. Part 340 is the frame holder.

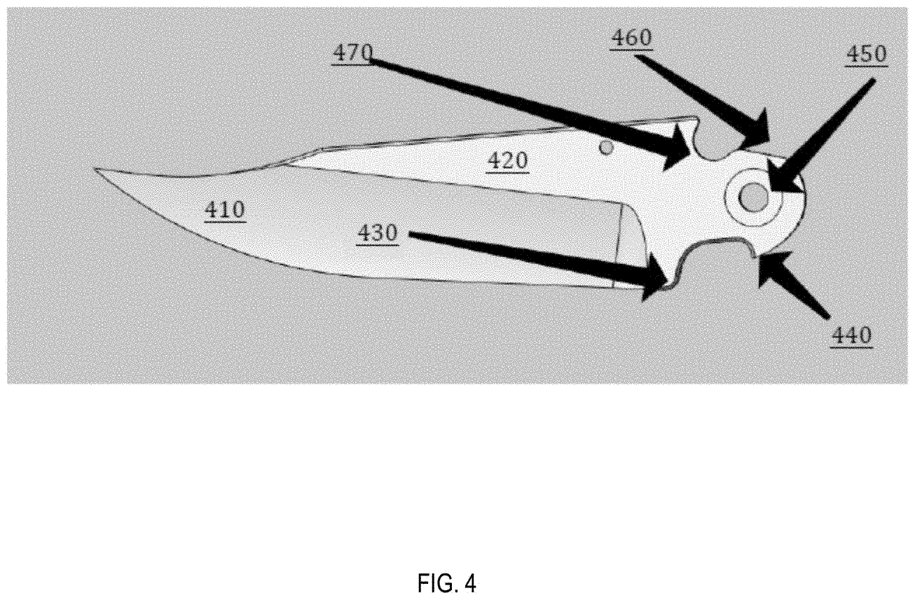

In one embodiment, FIG. 4 shows a typical blade. Many blade shapes can be accommodated by this invention, this is a bowie shape with part 410. Part 430 is used to interface a stop pin 140 in FIG. 1 when the knife is closed. Part 410 is combined with part 420 to form the rotating knife portion. Part 440 is used to interface the spindle 110 of FIG. 1 when the knife is closed. Part 450 is the pivot around which the knife rotates. Part 460 is a ramp that interfaces the spindle 110 of FIG. 1 when the knife is open. Part 470 is a curve that interfaces stop pin 150 of FIG. 1 when the knife is open.

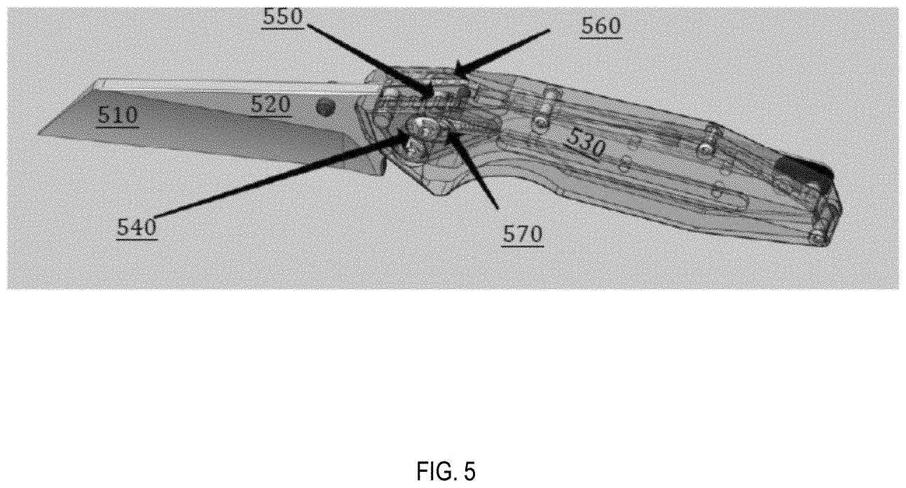

FIG. 5 shows the components required to assemble and repair the spindle lock mechanism. Part 510 is the blade that is combined with its cover Part 520 and held with frame holder 530. Part 540 is the left side screw which is similar to part 560. Part 550 is the spindle. The spindle has a solid core and is tapped on each end to accommodate parts 540 and 560. Part 570 is the spring that retains the spindle in place. To assemble a spindle mechanism, one needs to compress the wiper at 570 with a small tool, then press the spindle body 550 through the slots in the knife handle and spring covers, then release the spring and install the two screws 540 and 560 on either end of the spindle. Similarly, springs can be maintained or replaced by removing the spindle and then pushing the wiper 570 outward and then extracting the spring/wiper combination.

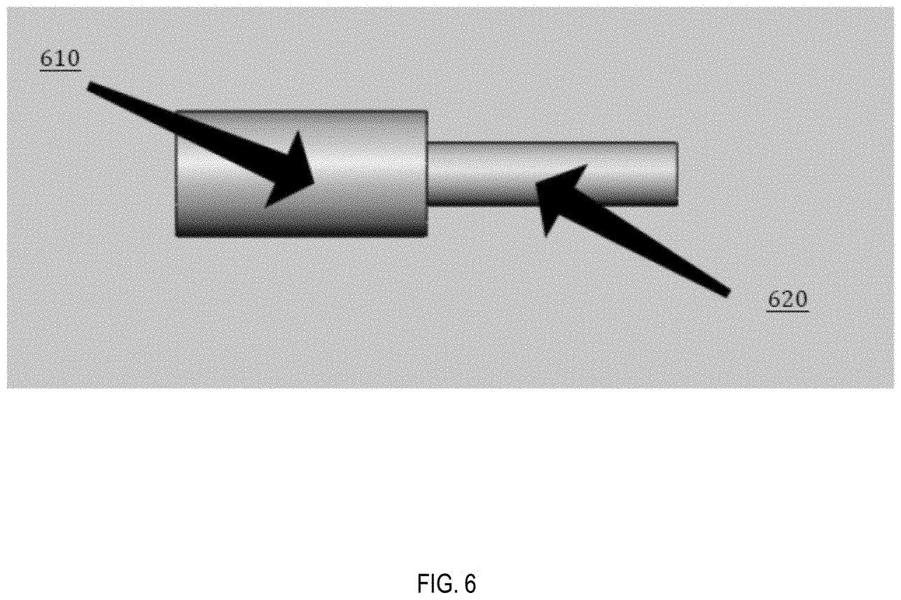

In FIG. 6 we show details of the wiper mechanism 1B. Ideally this has two properties. First the main body 610 is large enough to provide a wiper/cleaning action for the slot in the spring cover 180 of FIG. 1, preventing dust and debris from clogging the mechanism. Secondly, part 620 is used to aid in installation and removal of the wiper mechanism from the knife. In our preferred embodiment, this mechanism consists of a female threaded rod 610 with a male threaded rod 620 installed into it. The threads on 620 further aid in retaining the spring 130 in FIG. 1 in the mechanism.

Note that we can change the length of the element 610 and thereby change the amount of force placed on the spindle 110 in FIG. 1 by the spring/wiper combination 120/130 in FIG. 1. Changing that force effects how “stiff” the feel of the knife blade release is both the closed and open position and is a matter of “taste” in practice.

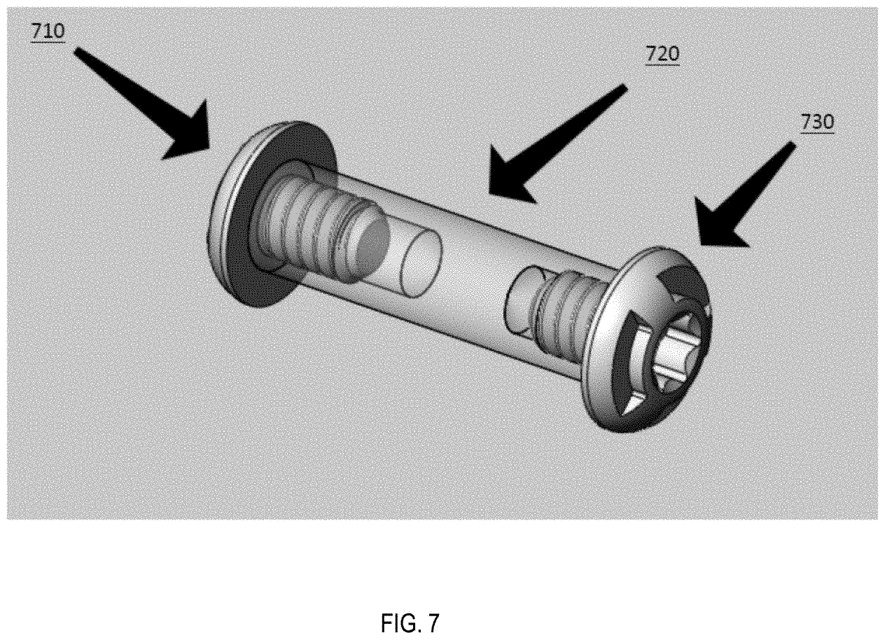

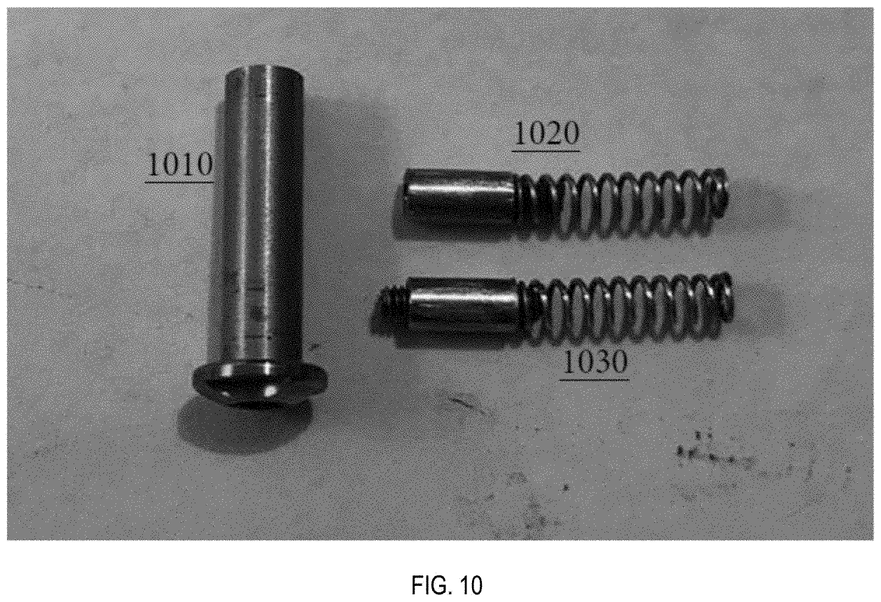

In one embodiment, FIGS. 7 and 10 show the spindle component used in the device. The device uses dual coil springs that sit in pockets in the frame on either side of the knife. The springs have guide rods that sit on top of them and they move with the lock. The guide rods are constructed out of a threaded piece of steel, which has a threaded rod inserted into them. The rod can be run in and out to change the effective length of the guide rod, which changes the compression of the springs. This allows the detent and release pressure to be changed. Removal of the springs can be done by removing the spindle. The spindle is solid core in the middle where the blade locks up with female threads on each end to allow for screws to be inserted into each end. Nothing on the spindle is physically attached to the spring guide rods, which means once the spindle is removed the guide rods and springs can be removed without tools. Additionally, the mechanism is sealed because only the guide rods are exposed. The springs always sit in pockets in the frame, and the guide rods create a dust seal.

In FIG. 7, we have two screws labeled 710 and 730 that thread into a spindle 720. The center part of the spindle is solid, providing maximum strength. Either or both parts 710 or 730 can be removed from the knife without disassembling any other part of the knife allowing the remaining parts to be removed from the knife for maintenance.

An additional advantage of the device is that the screws 710 and 730 can he made of a different material than the spindle 720. In one embodiment, the use of different materials allows us to use a hardened 440C material for 720 and then Titanium screws for 710 and 730. By having the screws be Titanium, we anodize them to match the other screws on the knife, which provides for a better look in the final product.

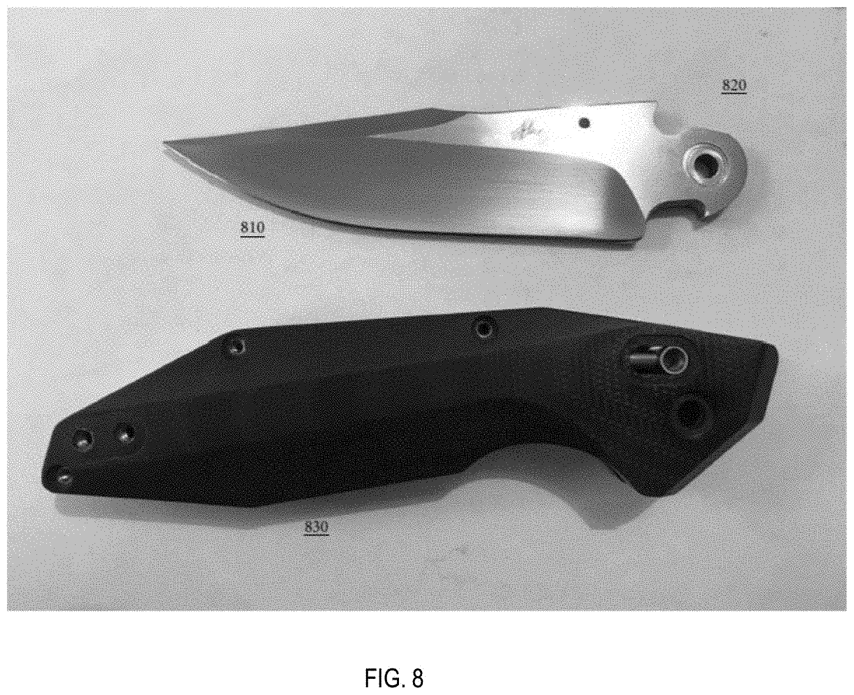

FIG. 8 shows the two disassembled part of a device according to one embodiment. Part 810 is a shape of the blade of the knife that partially rotates. Part 820 has the hooks that connects the Part 810 to the holder of the device 830. In different embodiments, the partially rotational part 820 is one or more of the following: clip point, drop point, tanto, sheepsfoot, dagger or needle point, spear point, trailing point, gut hook, bowie shape, hawkbill pruner, or wharncliffe shape. The partially rotational device can be a device in itself or be part of another device including one or more of the following handle took: comb, screwdriver, wrench, pick, plyers or flashlight.

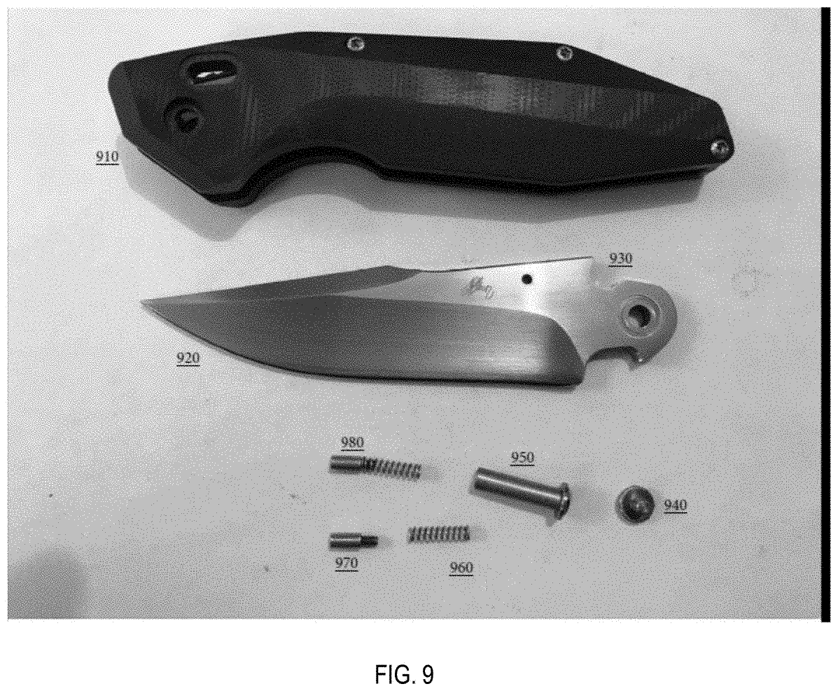

FIG. 9 shows various disassembled parts of a device according to one embodiment. Part 910 is the frame holder. Part 920 is the blade part of the rotational portion. Part 930 is the hook that is combined with Part 920 to connect with Part 910. Part 950 is the spindle that is used for the locking mechanism including opening and closing. Part 970 is the wiper. Part 960 is the compression spring. Part 940 is a screw used to assembly the parts together. Part 980 is a wiper combined with a compression spring part.

In one embodiment, FIG. 10 shows the spindle component used in the device. Part 1010 is the middle body of the spindle. The spindle is locked at both ends by compression spring and wiper components 1020 and 1030. Use of two springs, one on each side i.e. up and down side of the device, allows the spindle to be partially disassembled without having to disassemble the full knife. The springs and wiper components can be adjusted to varying lengths to adjust the rotational tension in the device that comes to play when a user opens or closes the device.

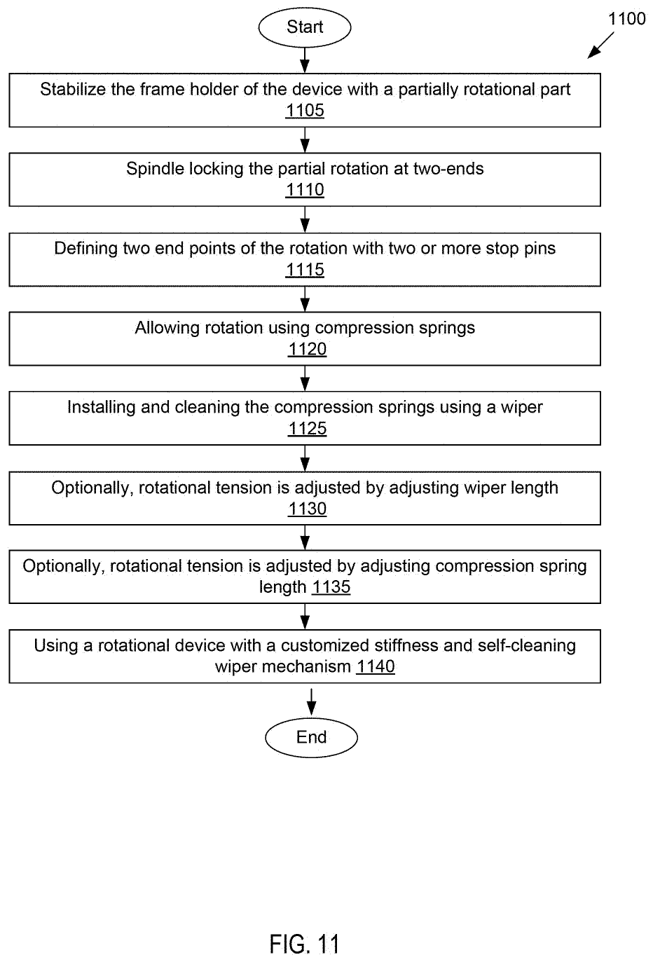

FIG. 11 is a flow diagram illustrating an example of steps of method in an apparatus and method of a knife with a customizable release stiffness, self-cleaning with a wiper and controlled rotation between two end-points. The flowchart 1100 is discussed in conjunction with the apparatus and method of a knife with flexible features shown in the diagram 100 in FIG. 1.

At block 1105, stabilize the frame holder of the device with a partially rotational part. At block 1110, spindle locking the partial rotation at two-ends using two or more stop pins. The location of the stop pins is based on the design or shape of the partially rotational part. The movement of the rotational part begins at one stop pin and ends at the other stop pin defining an opening point and a closing point for the device. At block 1115, defining the two end points of the rotation with two or more stop pins. At block 1120, the device allows the rotation using compression springs. At block 1125, installing and cleaning the compression spring using a wiper. At block 1130, optionally adjusting the rotational tension by adjusting the wiper length. At block 1135, optionally adjusting the rotational tension by adjusting the compression spring length. At block 1140, using the rotational device with a customized stiffness and self-cleaning wiper mechanism.

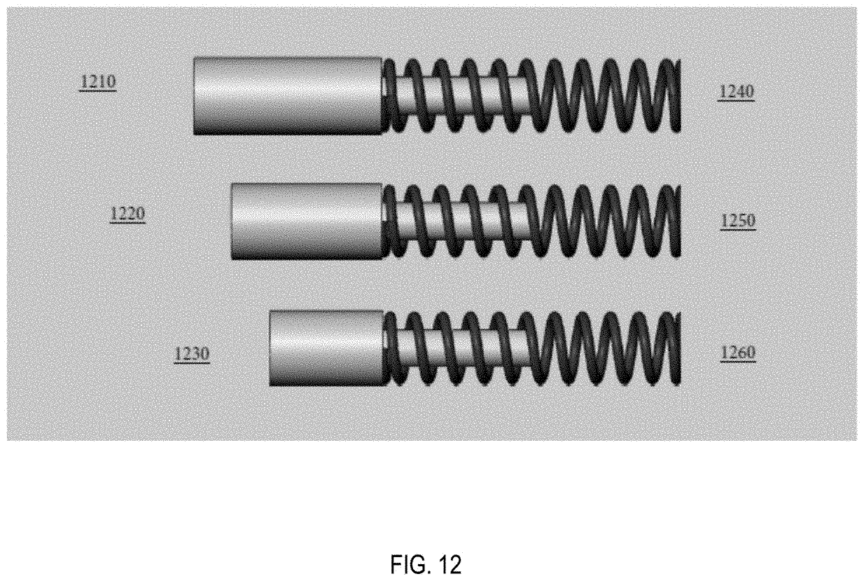

In one embodiment, FIG. 12 is a schematic diagram of exemplary wiper component with varying lengths, according to one embodiment. Part 1210, 1220 and 1230 are wiper components with varying lengths. Part 1240, 1250 and 1260 are the compression springs that are of the same length.

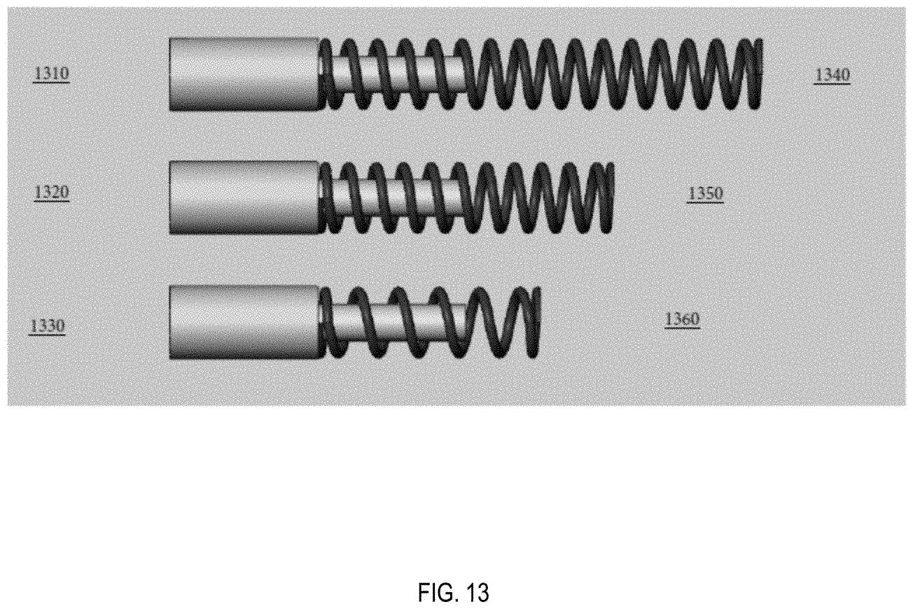

In one embodiment, FIG. 13 is a schematic diagram of exemplary compression spring component with varying lengths, according to one embodiment. Part 1310, 1320 and 1330 are wiper components with the same length. Part 1340, 1350 and 1360 are the compression springs that are of the varying lengths. In one embodiment, a mix and match of wiper and compression spring components are used to find an adjusted rotational tension for a user per his or her taste.

In one embodiment, an application on a mobile phone or a cloud-based software that may or may not include a web interface allows a user to select on the fly shape of the knife blade, the knife blade cover with hook, desired stiffness level to design different customized knives that the user can choose from and order.

In one embodiment, the user y purchase more than one wiper with varying lengths and more than one compression springs and change the tension of the device based on the social occasion. If the user is going camping and expecting lot of use of the rigid knife, the user may use appropriate wiper/compression spring combination. While on the other hand, if the user is going to a social occasion and wants to use the knife to cut meat or fruit, the user can adjust the tension accordingly.

The present disclosure describes techniques that those of skill in the art can implement in numerous ways. For instance, those of skill in the art can implement the techniques described here using a process, an apparatus, a system, a composition of matter, a computer program product embodied on a computer--readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used here, the term ‘processor’ refers to one or more devices, circuits, and/or processing cores configured to process data, such as computer program instructions,

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

It should be borne in mind, however, that terms are to be associated with the appropriate physical quantities and are merely convenient labels applied to these quantities.

Techniques described here relate to apparatus for performing the operations. The apparatus can be specially constructed for the required purposes, or it can comprise a general-purpose computer selectively activated or reconfigured by a computer program stored in the computer. Although the foregoing implementations have been described in some detail for purposes of clarity of understanding, implementations are not necessarily limited to the details provided.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tapes, disks, integrated circuits, and servers. The instructions are operational when executed by the processor to direct the processor to operate in accord with some embodiments. Those skilled in the art are familiar with instructions, processor(s), and storage medium.

1. A method of a folding and partially rotational knife, comprising:
stabilizing the frame holder of the knife for the axis on which a partially rotational knife blade rotates;
spindle locking the partial rotation at two-ends using a spindle with screws at each-end of the spindle;
forming a spring/wiper combination with a wiper and two or more compression springs;
pressing on the spindle by placing the spring/wiper combination adjacent to the spindle to allow adjustable tension for partially rotating the knife;
defining the two-ends for the rotation with two or more stop pins;
installing and cleaning the two or more compression springs of the spring/wiper combination using the wiper;
wherein tension of the partial rotation is adjusted by placement of one or more of the wiper or compression springs or adjusting one or more compression springs length.

2. The method of claim 1, wherein the spindle can be replaced without disassembling all the parts of the knife.

3. The method of claim 1, wherein the wiper removes debris collected during the rotation of the knife.

4. The method of claim 1, wherein one of the two-ends is the stop point when the knife is closed that prevents excessive rotation on closing and protects a user holding the knife.

5. The method of claim 1, wherein one of the two-ends is the stop point that allows the knife to be used as a rigid knife when opened.

6. The method of claim 1, wherein the spindle acts as a tensioned stop point that prevents the knife from accidently being closed.

7. The method of claim 1, wherein the knife blade is one or more of the following: clip point, drop point, tanto, sheepsfoot, dagger or needle point, spear point, trailing point, gut hook, bowie shape, hawkbill pruner, or wharncliffe shape.

8. The method of claim 1, wherein the partially rotational part is one or more of the following handle tools: comb, screwdriver, wrench, pick, plyers or flashlight.

9. The method of claim 1, wherein the wiper further comprising of two parts that are a female threaded part and a male threaded part installed into the female threaded part.

10. The method of claim 1, further comprising one of the following:
increasing the length of the wiper or the compression spring to increase the rotation tension of the knife; or decreasing the length of the wiper or the compression spring to decrease the rotation tension of the knife.

11. An apparatus of a folding and partially rotational knife, comprising:
a stable frame holder of the knife for the axis on which a partially rotational knife blade rotates;
a spindle lock for the partial rotation at two-ends;
a wiper and two or more compression springs to form a spring/wiper combination;
the spring/wiper combination adjacent to and press on the spindle to allow adjustable tension for partial rotation of the knife;
the two-ends defined for the rotation with two or more stop pins;
the wiper used to install and clean the two or more compression springs;
wherein tension of the partial rotation is adjusted by placement of one or more of the wiper or compression springs or adjusted one or more compression springs length.

12. The apparatus of claim 11, wherein the spindle can be replaced without disassembling all the parts of the knife.

13. The apparatus of claim 11, wherein the wiper removes debris collected during the rotation of the knife.

14. The apparatus of claim 11, wherein one of the two-ends is the stop point when the knife is closed that prevents excessive rotation on closing and protects a user holding the knife.

15. The apparatus of claim 11, wherein one of the two-ends is the stop point that allows the knife to be used as a rigid knife when opened.

16. The apparatus of claim 11, wherein the spindle acts as a tensioned stop point that prevents the knife from accidently being closed.

17. The apparatus of claim 11, wherein the knife blade is one or more of the following: clip point, drop point, tanto, sheepsfoot, dagger or needle point, spear point, trailing point, gut hook, bowie shape, hawkbill pruner, or wharncliffe shape.

18. The apparatus of claim 11, wherein the partially rotational part is one or more of the following handle tools: comb, screwdriver, wrench, pick, plyers or flashlight.

19. The apparatus of claim 11, wherein the wiper further comprising of two parts that is a female threaded part and a male threaded part install in the female threaded part.

20. The apparatus of claim 11, further comprising one of the following:
increased length of the wiper or the compression spring to increase the rotation tension of the knife; or
decreased length of the wiper or the compression spring to decrease the rotation tension of the knife.

21. The method of claim 1, further comprising one of the following:
partially disassembling the knife by disconnecting one end of the spring/wiper combination.

22. The apparatus of claim 11, further comprising one of the following:
disconnected one end of the spring/wiper combination to allow a partially dissembled knife.
